(19) United States
(12) Patent Application Publication
(10) Pub. No.: US 2022/0122210 A1
(43) Pub. Date: Apr. 21, 2022

(54) ENCOUNTER MANAGEMENT SYSTEM AND METHOD

(71) Applicant: Save-A-Life, Cincinnati, OH (US)

(72) Inventor: Daniel Kenyadasangria Frazier, Independence, KY (US)

(21) Appl. No.: 17/505,440

(22) Filed: Oct. 19, 2021

Related U.S. Application Data
(60) Provisional application No. 63/093,748, filed on Oct. 19, 2020.

(51) Int. Cl. G06Q 50/26; H04N 5/232; G06K 9/00

(52) U.S. Cl. CPC G06Q 50/26; G06K 9/00288; H04N 5/23206

(57) ABSTRACT

A system and method for managing an encounter between two parties, e.g., between a civilian and a public servant during a traffic stop, is provided. The system includes a backend platform, a mobile application, a navigation system, and other types of applications. During a traffic stop, the system provides a communications link between the civilian's mobile device and the public servant's mobile device so that the parties may communicate from within their respective vehicles without requiring face-to-face contact. The system enables the parties to exchange information with one another and to retrieve additional information from external systems such as the Department of Motor Vehicles, Police Department, etc. The system also enables the civilian to request a secondary public servant to be dispatched to the scene if he/she is not comfortable with the public servant that initiated the encounter.

### CROSS-REFERENCE TO RELATED APPLICATION

This application is a non-provisional application which claims priority to U.S. Provisional Patent Application No. 63/093,748 filed on Oct. 19, 2020, which is incorporated by reference in its entirety.

### FIELD OF THE INVENTION

This invention relates to communications systems, including a communication system that manages the aspects associated with an encounter between a civilian and a public servant.

### BACKGROUND

During an encounter between a civilian and a public servant (e.g., a police officer), the police officer may identify themselves and communicate the reason for the encounter (e.g., a traffic violation). During the encounter, the police officer may approach the civilian's vehicle for a face-to-face interaction, and the civilian may be asked to provide a valid driver's license, proof of insurance and other types of information. At the conclusion of the encounter, the police officer may issue a traffic violation ticket to the civilian if appropriate and the two may part ways.

However, there are times when such an encounter may go awry, may turn violent and may even end in death. Such encounters may include a case of mistaken identity, an incorrect assessment of behaviors due to an existing emotional and/or mental disorder, an incorrect assessment of a clear and present danger, or other types of mistakes that may prove deadly.

Accordingly, there is a need for a system that provides a communications link between a civilian and a public servant that may enable the two to interact with one another from within their respective vehicles during an encounter (while avoiding a face-to-face interaction) using their smartphones or other similar types of devices. There also is a need for a system that identifies emotional and/or mental disorders with one of the parties and provides guidance on best practices to deal with such disorders. There also is a need for a system that enables the dispatching of secondary public servants to the scene of the encounter as required to ensure the safety of those involved.

### SUMMARY

According to one aspect, one or more embodiments are provided below for a system and method for managing an encounter between two parties, e.g., between a civilian and a public servant. The method may include, by one or more computer systems, storing first information regarding the first public servant to a database, by the one or more computer systems, storing second information regarding the civilian to a database, using a navigation system, identifying a first physical location of a first client device associated with the first public servant and a second physical location of a second client device associated with the civilian, using the navigation system, determining if the first physical location and the second physical location are within a first predetermined distance from one another, in response to a determination that the first physical location and the second physical location are within the predetermined distance from one another, then: by the one or more computer systems, providing a first communication link between the first client device and the second client device and using the first communication link, providing at least some of the second information to the first client device and/or providing at least some of the first information to the second client device.

In another embodiment, the method may include, by the one or more computer systems, controlling a camera associated with the second client device to take a first photograph, and by the one or more computer systems, sending the first photograph from the second client device to the first client device.

In another embodiment, the method may include using the photograph to authenticate an identity of the civilian.

In another embodiment, the method may include receiving a request from the second client device to dispatch a second public servant to the first physical location and/or the second physical using, the navigation system, identifying a third physical location of a third client device associated with the second public servant, using the navigation system, determining if the third physical location is within a second predetermined distance of the first physical location and/or of the second physical location, and in response to a determination that the third physical location is within the second predetermined distance of the first physical location and/or of the second physical location, then: by the one or more computer systems, dispatching the second public servant to the first physical location and/or to the second physical location.

In another embodiment, the method may include using the navigation system, providing a real time indication of the location of the third client device to the first client device and/or to the second client device.

In another embodiment, the method may include, by the one or more computer systems, providing a second communication link between the first client device and the third client device and/or between the second client device and the third client device.

In another embodiment, the method may include, using the second communication link, providing at least some of the first information and/or at least some of the second information to the third client device.

In another embodiment, the method may include storing third information regarding the second public servant to a database and providing at least some of the third information to the first client device and/or to the second client device.

In another embodiment, the method may include enabling the first public servant to issue a traffic violation citation to the civilian and to send it from the first client device to the second client device, enabling the civilian to sign the traffic violation citation on the second client device, and sending the signed traffic violation citation from the second client device to the first client device.

In another embodiment, the method may include storing to a database at least some communications over the first communication link between the first client device and the second client device.

In another embodiment, the method may include, using the navigation system, determining if the first client device and the second client device are each at a standstill.

In another embodiment, the method may include, using the navigation system, determining if the first client device is behind the second client device.

According to another aspect, one or more embodiments are provided below for a system and method for managing an encounter between two parties, e.g., between a civilian and a public servant. The method may include, using a navigation system, identifying a first physical location of a first client device associated with the first public servant and a second physical location of a second client device associated with the civilian, using the navigation system, determining if the first physical location and the second physical location are within a first predetermined distance from one another, and in response to a determination that the first physical location and the second physical location are within the predetermined distance from one another, then: by the one or more computer systems, providing a first communication link between the first client device and the second client device, controlling a camera associated with the second client device to take a photograph, and using the first communications link, sending the photograph from the second client device to the first client device.

In another embodiment, the method may include using the photograph to authenticate an identity of the civilian.

In another embodiment, the method may include receiving a request from the second client device to dispatch a second public servant to the first physical location and/or the second physical location, using the navigation system, identifying a third physical location of a third client device associated with the second public servant, using the navigation system, determining if the third physical location is within a second predetermined distance of the first physical location and/or of the second physical lotion, and in response to a determination that the third physical location is within the second predetermined distance of the first physical location and/or of the second physical location, then: by the one or more computer systems, dispatching the second public servant to the first physical location and/or to the second physical locate on.

In another embodiment, the method may include, using the navigation system, providing a real time indication of the of the third client device to the first client device and/or to the second client device.

In another embodiment, the method may include providing a second communication link between the first client device and the third client device and/or between the second client device and the third client device.

In another embodiment, the method may include using the second. communication link, providing an authenticated identity of the civilian to the third client device.

In another embodiment, the method may include enabling the first public servant to issue a traffic violation citation to the civilian and to send it from the first client device to the second client device, enabling the civilian to sign the traffic violation citation on the second client device, and sending the signed traffic violation citation from the second client device to the first client device.

In another embodiment, the method may include storing to a database at least some communications over the first communication link between the first client device and the second client device.

The presently disclosed system and method for evaluating growing media is more fully described in the detailed description below.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification. None of the drawings are to scale unless specifically stated otherwise.

FIG. 1 shows an overview of an encounter management system framework in accordance with exemplary embodiments hereof;

FIG. 2 shows aspects of an encounter management system in accordance with exemplary embodiments hereof; and

FIG. 3 depicts aspects of computing and computer devices in accordance with exemplary embodiments hereof.

### DETAILED DESCRIPTION OF EXEMPLARY EMBODIMENTS

In general, the encounter management system and method according to exemplary embodiments hereof provides an application for establishing virtual communication between a public servant (e.g., a police officer) and a civilian during an encounter (e.g., during a traffic stop), and for providing both parties with pertinent information during the ensuing interaction. In one example, the application may be used during a traffic stop to enable the public servant and the civilian driver to communicate with one another while remaining in their respective vehicles, and to exchange pertinent information regarding the encounter without the need for a physical face-to-face contact. In other examples, the system may provide the public servant with information regarding any mental and/or emotional disabilities the civilian may have, behaviors associated with such disabilities, and tactics the public servant may use to ensure a peaceful and safe interaction. This information may be provided via accredited psychologists, psychiatrists, and/or other types of therapists. In another example, the application may provide the civilian with information relating to the work history of the particular public servant for his/her review. In other examples, the system may provide the civilian with the location of secondary public servants in the area with the option of requesting their assistance. In other examples, the system may document and/or record various aspects of the encounter for record keeping purposes. The application also may provide additional functionalities as will be described herein.

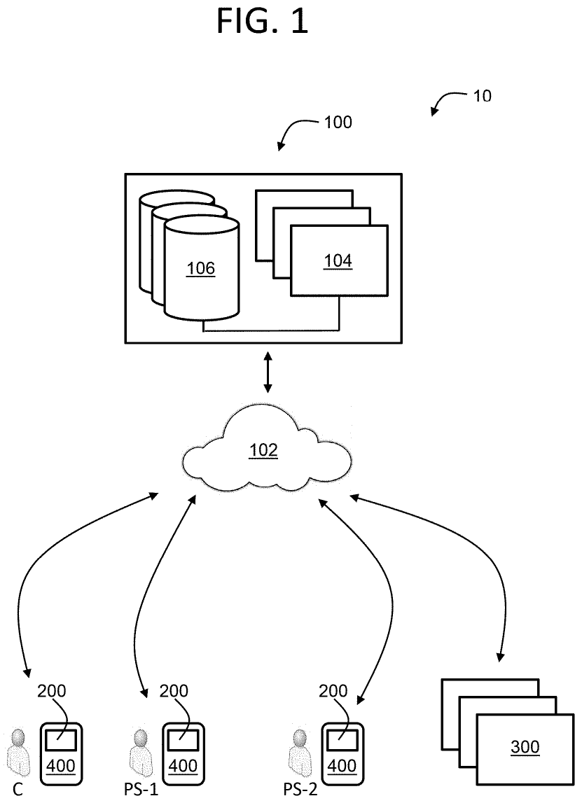

FIG. 1 shows an overview of an exemplary framework for an encounter management system 10 (also referred to simply as the system 10) according to exemplary embodiments hereof. As shown, the encounter management system 10 may include a backend system 100 that may interface with one or more applications 200 (e.g., a mobile application or “app”, a website viewed using a browser, or other types of applications). The interface may include a network 102 (e.g., the Internet, LAN, WAN, etc.), wireless communication systems, cellular communication systems, telephony or other types of communication systems or protocols.

The system 10 may be accessed by multiple users, e.g., one or more civilians Cs and/or public servants PSs, via the network 102 and using the mobile application 200 running on one or more computing devices 400 (e.g., smart phones, tablet computers, laptops, desktop computers, mobile media players, etc.).

The system 10 also may interface with external systems 300 to retrieve information from the civilian C and/or from the public servant PS and to share the information with the external systems 300, and/or to retrieve information from the external systems 300 and provide it to the civilian C and/or to the public servant PS. In some examples, the external systems 300 may include the Department of Motor Vehicles (DMV), police dispatchers, databases and/or systems that include information regarding police records, driver information, legal information, and other types of information, and/or other types of external systems 300.

In some embodiments, the backend system 100 may include a cloud platform (e.g., one or more backend servers), one or more local controllers, or any combination thereof. In some embodiments, the backend system 100 includes a cloud platform that interfaces with one or more local controllers. For example, administrators of the system 10 may interface with the system 10 via a local controller in communication with a cloud platform.

The backend system 100 may include a plurality of applications 104 and databases 106 as will be described in other sections.

For the purposes of this specification, the system 10 will be described predominantly with respect to providing management functionalities during an encounter between a civilian driver C and a public servant PS (e.g., a police officer) during a traffic stop. However, it is understood that the system 10 may be used to provide management functionalities to any type of encounter between any type of civilian and any type(s) of public servant, and that the scope of the system 10 is not limited in any way by the type of encounter(s) and/or by the persons involved in the encounter(s). For example, the system 10 may be used to monitor and manage an encounter between a civilian C and a 911 operator while providing similar functionalities to each of the parties (e.g., video communications so that the dispatcher may physically see what is happening at the scene, GPS location of the civilian C for the dispatching of emergency personnel, etc.). The system 10 also may be used to monitor and manage encounters between civilians C and paramedics, fire fighters, and other types of appropriate personnel.

In some embodiments, the encounter management system 10 may perform at least some of the following (in real time) prior to and/or during an encounter between a civilian C and a public servant PS:
1. Continually monitor the location and status of users of the system 10 (civilians C and public servants PS) to determine when an encounter is about to occur, and automatically turn on when such a determination is made. The location of each user may be determined by determining the location of each user's respective client device 400 using a navigation system running on the app 200 and/or on the backend platform 100. By recognizing when at least one civilian C is in close proximity to at least one public servant PS (e.g., within 50 feet), and both the civilian C and the public servant PS are coming to a stop or at a standstill, the system 10 may determine that an encounter between the civilian C and the public servant PS is about to occur. When this happens, the system 10 may automatically turn on at least some of its encounter monitoring/management functionalities (e.g., on the app 200 running on the client devices 400) as described herein.
2. Establish a virtual communication link between a public servant PS (e.g., a police officer) and a civilian C during an encounter (e.g., during a traffic stop). This may include video conferencing, audio conferencing, textual communications, other types of communication platforms, and any combinations thereof.
3. Enable the civilian C to share information with the public servant PS, and the public servant PS to share information with the civilian C via their respective electronic devices 400. The information may be in the form of digital images (e.g., a photograph or image of the civilian's C's driver's license taking using a camera associated with the civilian's C's client device 400, proof of insurance, etc.), a digital ID, video information, textual information, graphical information, audio information, other types of information and any combinations thereof.
4. Provide the police officer PS with information regarding the driver's identity, driving record, insurance status, indication of concealed-carry weapons (CCW) permit, any criminal records, etc. This information may be received from an external system 300 (e.g., the DMV, police records, etc.).
5. Provide the civilian driver C with details of the police officer's policing record, complaints, shootings, reviews, etc. This information may be received from an external system 300 (e.g., police records and/or files).
6. Provide the civilian C with information regarding the reason for the encounter (e.g., the reason for the traffic stop).
7. Provide the police officer PS with information regarding any mental and/or emotional disabilities the civilian C may have, including particular behaviors that may manifest because of the disabilities and tactics the police officer PS may use to ensure a peaceful and safe interaction. This information may be provided by an external system 300 such as accredited psychologists, psychiatrists, therapist, and/or other types of professional service providers.
8. Provide the civilian C with the option to request a secondary officer PS-2 to be physically dispatched to the location if the civilian C is not comfortable with the current officer PS-1 given the encounter and the officer's information provided to the civilian C. The system 10 may include a navigation system (e.g., a map displayed on a device 400 by the app 200) that shows the location of other officers/PSs in the area that may be called, and an interface with local police dispatchers that may dispatch the secondary officer PS-2 to the scene of the encounter.
9. Enable the police officer PS to issue a traffic violation citation to the civilian C virtually through the system 10 without having physical face-to-face contact with the civilian C. This also may include providing functionality for the civilian C to sign the citation on his/her device 400 and to return the signed copy back to the public servant PS.
10. Document, record (e.g., video, audio, etc.), log, and/or file information regarding various aspects of the encounter.
11. Other types of functionalities as described herein.

In some embodiments, a civilian C and a public servant PS may each have a computing device 400 (e.g., smart phone, tablet computer, laptop, mobile media player, dashboard console, etc.) that may store and run the application 200. It may be preferable that each user C, PS of the system 10 register with the system 10 prior to use by providing identity information and authentication, contact information, driver's license information, professional identification information (e.g., police officer's badge number, etc.), and other pertinent information. In this way, the system 10 may recognize and identify each user C, PS prior to, during, and after any encounters.

Upon entering into an encounter with one another (e.g., during a traffic stop), the civilian C and the public servant PS may both launch the application 200 on his/her respective device 400 and log in as required. In some embodiments, with the civilian C and the public servant PS each logged into the application 200 and the system 10, the system 10 may commence with managing the encounter as described herein.

In some embodiments, the public servant's application 200 may be different than the civilian's application 200 with regards to the graphic user interfaces (GUIs) of each, the functionalities of each, the external systems 300 that may be accessed using each application 200, etc. For example, the public servant's application 200 may interface with the DMV while the civilian's application 200 may not.

In some embodiments, the system 10 and/or the application 200 includes voice recognition/activation capabilities so that all or some of the functional controls of the app 200 may be controlled using spoken voice. This may enable, for example, the civilian C to minimize his/her movements within his/her car while controlling the app 200 by voice to connect with the public servant PS. By enabling the civilian C to remain essentially motionless while the system 10 connects the two parties together, unnecessary movements that may lead to unfortunate misinterpretations by the public servant PS as to the intentions of the civilian C may be avoided. Voice control capabilities also may generally enable the app 200 to be more easily and conveniently controlled by either party throughout the encounter.

In addition, it is preferable that the system 10 and the app 200 conform to industry accepted privacy regulations during operation.

Additional embodiments and details of the system 10 will be described by way of detailed use examples. The use examples provided below are chosen to illustrate various embodiments and implementations of the system 10, and those of ordinary skill in the art will appreciate and understand, upon reading this description, that the examples are not limiting and that the system 10 may be used in different ways. It also is understood that details and elements of different embodiments described in different scenarios and examples may be combined in any way to form additional embodiments that are all within the scope of the system 10.

### Example #1:

In a first example, a public servant PS (e.g., a police officer) may pull over a civilian C for a traffic violation. The general acts taken by the civilian C, the primary public servant PS-1, the secondary public servant PS-2 (optional) and/or the system 10 in this scenario may include at least some of the following (without limitation).

As the public servant PS and the civilian C are pulling over in preparation of an encounter, the system 10 (by continually monitoring the location and status of the civilian C and the public servant PS) recognizes that the civilian C and the public servant PS are within a minimum threshold distance of one another (e.g., within 50 feet of each other) and that both are coming to a stop (e.g., decelerating below a minimum threshold speed) or already at a complete stop (preferably with the public servant PS physically located behind the civilian C as during a traffic stop). Upon recognizing one or more of these criteria, the system 10 determines that an encounter between the two parties is about to occur and automatically turns on its encounter monitoring/management functionalities for both the civilian C and the public servant PS (i.e., the system 10 launches the civilian's C's app 200 and the public servant's PS's app 200 and begins operation). In this way, the system 10 may ensure that the appropriate functionalities of the system 10 are operational without relying on the civilian C and/or the public servant PS.

Alternatively, the civilian C and/or the public servant PS may log into his/her application 200 manually using his/her computing device 400 (e.g., smartphone, dashboard console, etc.).

With both the civilian C and the public servant PS logged into the system 10, the system 10 may associate the civilian C with the public servant PS as entering into an encounter with one another and log the encounter with a location and time stamp into its encounter database 122. The system 10 also may log the identity of the participants of the encounter (e.g., the civilian C and the public servant PS), the reason for the encounter and/or other information. In some embodiments, the system 10 may require either the civilian C and/or the public servant PS to confirm the information prior to its being logged. However, this may not be necessary.

In some embodiments, the system 10 may automatically and continually log each aspect of each interaction between the civilian C and the public servant PS, each action taken by the civilian C, each action taken by the public servant PS, each action taken by the system 10, each action taken by an external system 300, and other information during the encounter. In other embodiments, the system 10 may be manually triggered (e.g., by the civilian C, by the public servant PS, and/or by other entities) to log various aspects of the encounter. For example, in some embodiments the system 10 may query the civilian C and/or the public servant PS and ask if either party wishes to log a particular aspect of the encounter (e.g., an audio conversation between the two). In other embodiments, the system 10 may log some aspects of the encounter automatically and be manually triggered to log other aspects of the encounter.

Once both parties have logged into the system 10, the system 10 may next establish a communication link between the civilian C and the public servant PS so that the two may communicate with one another through the system 10. This may include a video communication link, an audio communication link, a textual communication link, other types of communication links or platforms, and any combinations thereof. For example, the application 200 running on the civilian's device 400 may display a real time image (e.g., video) of the public servant PS with real time audio, and the application 200 running on the public servant's device 400 may display a real time image (e.g., video) of the civilian C with real time audio. This communication link may enable the civilian C and the public servant PS to interact with one another, to pose and answer questions each may have, and to generally interact regarding the nature of the encounter while remaining in their respective vehicles.

In addition to the communication link, the system 10 may provide an information transfer link for the civilian C to provide information, images, video, digital IDs, digital proof of insurance files, and other pertinent information to the public servant PS. The information may be provided by taking a picture using a camera associated with the user's computing device 400 (e.g., taking a picture of his/her driver's license), by choosing a digital ID or other digital document stored on the computing device 400, by typing text into the application 200 using a keyboard associated with the computing device 400, or by other means. For example, in some embodiments, the app 200 may control a camera associated with the civilian's C's device 400 to take a picture of his/her driver's license and to send it to the public servant's PS's device 400. In this example, the app 200 may launch a graphical user interface wizard that guides the civilian C through the process of taking the picture of his/her driver's license in high resolution, control the camera to take the photograph, and to transfer the photograph to the public servant's PS's device 400 via a secure private communications link.

The system 10 also may provide an information transfer link for the public servant PS to provide information, images, video, digital IDs, and other pertinent information to the civilian C using the same or similar methodologies.

The system 10 also may provide communication links to external systems 300 for the civilian C and/or the public servant PS to interact with and to upload and/or acquire additional information. For example, the public servant PS may be provided a communication link to a database associated with the DMV to access the driving records of the civilian C. The public servant PS also may be provided a link to a database associated with police records to acquire any criminal records of the civilian C, any indication of a concealed-carry weapons (CCW) permit that the civilian C may have, and other types of information.

The system 10 also may provide the public servant PS with information regarding any mental and/or emotional disabilities the civilian C may have, including particular behaviors that may manifest because of the disabilities, and tactics the police officer PS may use to ensure a peaceful and safe interaction. This information may be provided by an external system 300 such as an accredited psychologist, psychiatrist, therapist, and/or other types of profession services. This information also may be provided through a mental health association and/or a database associated with such an association. It is preferred that the information provided by such an external system 300 be certified and confirmed as correct and accurate.

In another example, the civilian C may be provided a communications link to a database or other type of information service associated with the police officer's policing record, arrests, complaints, shootings, reviews, etc. so that the civilian may assess the public servant's history.

Once the civilian C has reviewed the primary public servant's policing records, the system 10 may provide the civilian C with the opportunity to request a secondary public servant PS-2 (e.g., a different police officer in the area) to be dispatched to the scene of the encounter. If the civilian C wishes to do this, the system 10 may locate one or more candidate secondary public servants PS-2 currently located in the area (e.g., within a radius of 5 miles or other appropriate distance of the scene) that may potentially be dispatched to the scene. The civilian C may then request access to the candidate secondary public servant's policing records, and after review, may decide whether or not to request the dispatch of the one or more secondary public servants PS-2. Once requested, the system 10 may communicate the request to the police dispatcher and confirm with the civilian C that the request has been entered and that the secondary public servant PS-2 is on their way. The system 10 may then enable the civilian C to track the movement of the secondary public servant PS-2 using its navigation application 110 (e.g., by displaying an real time map on the display of his/her device 400). The primary public servant PS-1 also may be notified that a secondary public servant PS-2 has been dispatched so that he/she may know to await their arrival.

Once the secondary public servant PS-2 has been dispatched to the scene of the encounter, the system 10 may provide him/her with all of the information pertaining to the encounter already logged by the system 10 such as the reason for the encounter, the identity of the civilian C and of the primary public servant PS-1, the driving records of the civilian, the policing history of the primary public servant PS-1, mental and/or emotional disorder of the civilian, and/or other pertinent information regarding the encounter. In some embodiments, this information may be provided through the application 200 running on the secondary public servant's PS-2's device 400.

Upon the arrival of the secondary public servant PS-2 (or at any appropriate time), the system 10 may link the secondary public servant PS-2 into the same virtual communication link as provided to the civilian C and the primary public servant PS-1 so that all three may communicate via the system 10 in real time.

If at any time a physical face-to-face interaction between the civilian C and the primary public servant PS-1 and/or the secondary public servant PS-2 is deemed necessary, the system 10 may alert the civilian C and may log this determination. The system 10 also may interface with cameras worn by the primary and/or the secondary public servants PS-1, PS-2, and with any vehicle cameras configured with the vehicles of the primary and/or secondary public servants PS-1, PS-2. The system 10 also may log and store any associated video captured by the cameras.

At the conclusion of the encounter, the system 10 may enable the public servant PS to issue a traffic violation ticket to the civilian C (if applicable) through the application 200, without the need for face-to-face contact. Additional information concluding the encounter also may be provided to both the civilian C and/or the public servant PS.

It is understood that the summary of steps described above is meant for demonstration and that the actual process may include additional steps not listed and/or less steps than listed. It is also understood that any of the steps may be performed in any different order.

### System Structure

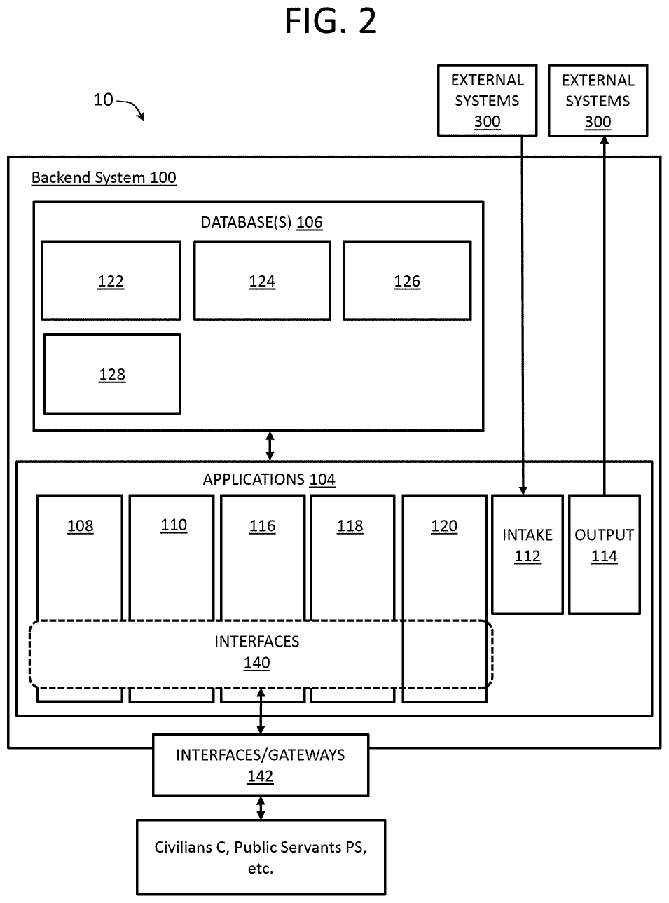

FIG. 2 shows aspects of an exemplary encounter management system 10 of FIG. 1. As shown, the system 10 and backend system 100 comprises various internal applications 104 and one or more databases 106, described in greater detail below. The internal applications 104 may generally interact with the one or more databases 106 and with the data stored therein.

The database(s) 106 may comprise one or more separate or integrated databases, at least some of which may be distributed. The database(s) 106 may be implemented in any manner, and, when made up of more than one database, the various databases need not all be implemented in the same way. It should be appreciated that the system is not limited by the nature or location of database(s) 106 or by the manner in which they are implemented.

Each of the internal applications 104 may provide one or more services via an appropriate interface. Although shown as separate applications 104 for the sake of this description, it is appreciated that some or all of the various applications 104 may be combined. The various applications 104 may be implemented in any manner and need not all be implemented in the same way (e.g., using the same software languages, interfaces, or protocols).

In some embodiments, the applications 104 may include one or more of the following applications 104:
1. Communication application(s) 108. This application may include any and all of the applications necessary to establish any types of communications links between the civilian C and the public servant(s) PS, as well as between any other parties (e.g., a dispatcher, 911 operator, etc.) as required.
2. Navigational application(s) 110. This application includes a Global Positioning System (GPS) or other types of geolocation systems to locate the position and status of the civilian C, the primary public servant PS-1, the secondary public servant(s) PS-2 (optional as required), and any other types of locations as required by the system 10.
3. Data input application(s) 112. This application may input any type of data from any applicable system and/or element such as the application(s) 200, external systems 300, any other system and/or element and any combination thereof.
4. Data output application(s) 114. This application may output any type of data to any applicable system and/or element such as the application(s) 200, the external systems 300, any other system and/or element and any combination thereof.
5. Dispatching application(s) 116. This application may provide the functionalities necessary to dispatch any secondary public servant PS-2 to the scene of the encounter as required.
5. Data reporting application(s) 118. This application may generate any type of report regarding the use and/or functionalities of the system 10 including all information logged by the system 10 during any encounter, any other types of data and/or information and any combination thereof.
6. Device 400 control application(s) 120. This application may control the civilian's C's device 400 and/or the public servant's PS's device 400. For example, the application 120 may control a camera associated with the civilian's C's device 400 to take high resolution photographs of the civilian's C's driver's license and send it to the public servant's PS's device 400.
6. The applications 104 also may include other applications and/or auxiliary applications (not shown). Those of ordinary skill in the art will appreciate and understand, upon reading this description, that the above list of applications is meant for demonstration and that the system 10 may include other applications that may be necessary for the system 10 to generally perform its functionalities as described in this specification. In addition, as should be appreciated, embodiments or implementations of the system 10 need not include all of the applications listed, and that some or all of the applications may be optional. It is also understood that the scope of the system 10 is not limited in any way by the applications that it may include.

In some embodiments, the database(s) 106 may include one or more of the following databases 106:
1. User information database(s) 122. This database may store any type of registration and/or profile information for any civilian C, public servant PS and/or any other type of user of the system 10.
2. Encounter database(s) 124. This database may store information regarding each encounter logged by the system 10.
3. Data report(s) database(s) 126. This database may store any reports of any kind generated by the system 10.
4. Miscellaneous database(s) 128. These databases may include ancillary databases as required by the system 10.

It is understood that the above list of databases is meant for demonstration and that the system 10 may include some or all of the databases, and also may include additional databases as required. It is also understood that the scope of the system 10 is not limited in any way by the databases that it may include.

Various applications 104 and databases 106 in the encounter management system 10 may be accessible via interface(s) 140. These interfaces 140 may be provided in the form of APIs or the like and made accessible to external users C, PS via one or more gateways and interfaces 142 (e.g., via a web-based application 200 and/or a mobile application 200 running on a client's personal device 400 such as a mobile phone, tablet computer, desktop computer, laptop computer, etc.).

It is understood that any aspect and/or element of any embodiment described herein or otherwise may be combined in any way to form new embodiments all of which are easily understood by a person of ordinary skill in the art and all of which are within the scope of the system 10.

Those of ordinary skill in the art will appreciate and understand, upon reading this description, that embodiments hereof may provide different and/or other advantages, and that not all embodiments or implementations need have all advantages.

### Application 200

In some embodiments, the application 200 resides on an electronic device 400 such as a smartphone, a tablet computer, a laptop computer, a dashboard console, a mobile music player, other types of electronic devices, and any combination thereof. The application 200 includes a graphical user interface (GUI) that may be presented on the device's display and that includes controls (e.g., touchscreen and/or mechanical buttons, etc.) that a civilian C and/or the public servant PS may activate to interact with the system 10. For example, the GUI may include controls and/or other mechanisms that enable the users C, PS to interface with the system 10 during its general usage (e.g., to log into the system 10, establish a communication link, exchange information, download information, request a secondary public servant PS-2, etc.). Other types of controls may include buttons, dials, check boxes, drop-down menus, scroll bars, other types of controls and any combination thereof.

In some embodiments, the application 200 includes voice recognition capabilities so that it may receive and implement voice commands from the users C, PS. In addition, the application 200 may accommodate any language.

In some embodiments, the application 200 may present instructions, wizards, and/or other types of guidance to the users C, PS via the GUI.

### Computing

The services, mechanisms, operations, and acts shown and described above are implemented, at least in part, by software running on one or more computers or computer systems or devices. It should be appreciated that each user device is, or comprises, a computer system.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

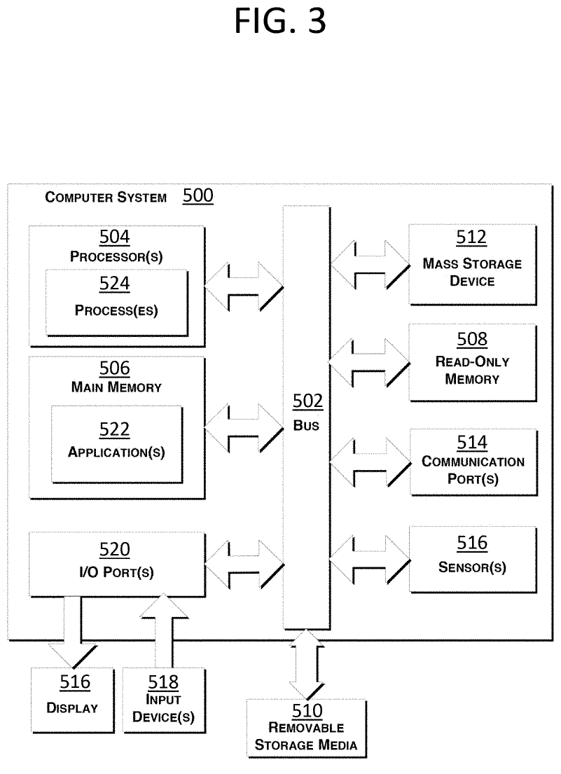

FIG. 3 is a schematic diagram of a computer system 500 upon which embodiments of the present disclosure may be implemented and carried out.

According to the present example, the computer system 500 includes a bus 502 (i.e., interconnect), one or more processors 504, one or more communications ports 514, a main memory 506, removable storage media 510, read-only memory 508, and a mass storage device 512. Communication port(s) 514 may be connected to one or more networks by way of which the computer system 500 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 504 can be (or include) any known processor, such as, but not limited to, an Intel® Itanium® or Itanium 2® processor(s), AMD® Opteron® or Athlon MP® processor(s), or Motorola® lines of processors, and the like. Communications port(s) 514 can be any of an RS-232 port for use with a modem based dial-up connection, a 10/100 Ethernet port, a Gigabit port using copper or fiber, or a USB port, and the like. Communications port(s) 514 may be chosen depending on a network such as a Local Area Network (LAN), a Wide Area Network (WAN), a CDN, or any network to which the computer system 500 connects. The computer system 500 may be in communication with peripheral devices (e.g., display screen 516, input device(s) 518) via Input/Output (I/O) port 520. Some or all of the peripheral devices may be integrated into the computer system 500, and the input device(s) 518 may be integrated into the display screen 516 (e.g., in the case of a touch screen).

Main memory 506 can be Random Access Memory (RAM), or any other dynamic storage device(s) commonly known in the art. Read-only memory 508 can be any static storage device(s) such as Programmable Read-Only Memory (PROM) chips for storing static information such as instructions for processor(s) 504. Mass storage 512 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 502 communicatively couples processor(s) 504 with the other memory, storage and communications blocks. Bus 502 can be a PCI/PCI-X, SCSI, a Universal Serial Bus (USB) based system bus (or other) depending on the storage devices used, and the like. Removable storage media 510 can be any kind of external hard-drives, floppy drives, IOMEGA® Zip Drives, Compact Disc—Read Only Memory (CD-ROM), Compact Disc—Re-Writable (CD-RW), Digital Versatile Disk—Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements that are appropriate to perform the methods.

As shown, main memory 506 is encoded with application(s) 522 that support(s) the functionality as discussed herein (an application 522 may be an application that provides some or all of the functionality of one or more of the mechanisms described herein). Application(s) 522 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 504 accesses main memory 506 via the use of bus 502 in order to launch, run, execute, interpret or otherwise perform the logic instructions of the application(s) 522. Execution of application(s) 522 produces processing functionality of the service(s) or mechanism(s) related to the application(s). In other words, the process(es) 524 represents one or more portions of the application(s) 522 performing within or upon the processor(s) 504 in the computer system 500.

It should be noted that, in addition to the process(es) 524 that carries(carry) out operations as discussed herein, other embodiments herein include the application 522 itself (i.e., the un-executed or non-performing logic instructions and/or data). The application 522 may be stored on a computer readable medium (e.g., a repository) such as a disk or in an optical medium. According to other embodiments, the application 522 can also be stored in a memory type system such as in firmware, read only memory (ROM), or, as in this example, as executable code within the main memory 506 (e.g., within Random Access Memory or RAM). For example, application 522 may also be stored in removable storage media 510, read-only memory 508, and/or mass storage device 512.

Those skilled in the art will understand that the computer system 500 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering.

No ordering is implied by any of the labeled boxes in any of the flow diagrams unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A computer implemented method of managing an encounter between a first public servant and a civilian, the method comprising:
(A) by one or more computer systems, storing first information regarding the first public servant to a database;
(B) by the one or more computer systems, storing second information regarding the civilian to a database;
(C) using a navigation system, identifying a first physical location of a first client device associated with the first public servant and a second physical location of a second client device associated with the civilian;
(D) using the navigation system, determining if the first physical location and the second physical location are within a first predetermined distance from one another;
(E) in response to a determination that the first physical location and the second physical location are within the predetermined distance from one another, then:
(F) by the one or more computer systems, providing a first communication link between the first client device and the second client device; and
(G) using the first communication link, providing at least some of the second information to the first client device and/or providing at least some of the first information to the second client device.

2. The computer implemented method of claim 1 further comprising:
(H) by the one or more computer systems, controlling a camera associated with the second client device to take a first photograph;
(I) by the one or more computer systems, sending the first photograph from the second client device to the first client device.

3. The computer implemented method of claim 2 further comprising:
(J) using the photograph to authenticate an identity of the civilian.

4. The computer implemented method of claim 1 further comprising:
(H) receiving a request from the second client device to dispatch a second public servant to the first physical location and/or the second physical location;
(I) using the navigation system, identifying a third physical location of a third client device associated with the second public servant;
(J) using the navigation system, determining if the third physical location is within a second predetermined distance of the first physical location and/or of the second physical location;
(K) in response to a determination that the third physical location is within the second predetermined distance of the first physical location and/or of the second physical location, then:
(L) by the one or more computer systems, dispatching the second public servant to the first physical location and/or to the second physical location.

5. The computer implemented method of claim 4 further comprising:
(M) using the navigation system, providing a real time indication of the location of the third client device to the first client device and/or to the second client device.

6. The computer implemented method of claim 5 further comprising:
(N) by the one or more computer systems, providing a second communication link between the first client device and the third client device and/or between the second client device and the third client device.

7. The computer implemented method of claim 6 further comprising:
(O) using the second communication link, providing at least some of the first information and/or at least some of the second information to the third client device.

8. The computer implemented method of claim 7 further comprising:
(P) storing third information regarding the second public servant to a database;
(Q) providing at least some of the third information to the first client device and/or to the second client device.

9. The computer implemented method of claim 1 further comprising:
(H) enabling the first public servant to issue a traffic violation citation to the civilian and to send it from the first client device to the second client device;
(I) enabling the civilian to sign the traffic violation citation on the second client device;
(J) sending the signed traffic violation citation from the second client device to the first client device.

10. The computer implemented method of claim 1 further comprising:
(F)(1)storing to a database at least some communications over the first communication link between the first client device and the second client device.

11. The computer implemented method of claim 1 further comprising:
(E)(1) using the navigation system, determining if the first client device and the second client device are each at a standstill.

12. The computer implemented method of claim 11 further comprising:
(E)(2) using the navigation system, determining if the first client device is behind the second client device.

13. A computer implemented method of managing an encounter between a first public servant and a civilian, the method comprising:
(A) using a navigation system, identifying a first physical location of a first client device associated with the first public servant and a second physical location of a second client device associated with the civilian;
(B) using the navigation system, determining if the first physical location and the second physical location are within a first predetermined distance from one another;
(C) in response to a determination that the first physical location and the second physical location are within the predetermined distance from one another, then:
(D) by the one or more computer systems, providing a first communication link between the first client device and the second client device;
(E) controlling a camera associated with the second client device to take a photograph;
(F) using the first communications link, sending the photograph from the second client device to the first client device.

14. The computer implemented method of claim 13 further comprising:
(G) using the photograph to authenticate an identity of the civilian.

15. The computer implemented method of claim 13 further comprising:
(H) receiving a request from the second client device to dispatch a second public servant to the first physical location and/or the second physical location;
(I) using the navigation system, identifying a third physical location of a third client device associated with the second public servant;
(J) using the navigation system, determining if the third physical location is within a second predetermined distance of the first physical location and/or of the second physical location;
(K) in response to a determination that the third physical location is within the second predetermined distance of the first physical location and/or of the second physical location, then:
(L) by the one or more computer systems, dispatching the second public servant to the first physical location and/or to the second physical location.

16. The computer implemented method of claim 15 further comprising:
(M) using the navigation system, providing a real time indication of the location of the third client device to the first client device and/or to the second client device.

17. The computer implemented method of claim 16 further comprising:
(N) providing a second communication link between the first client device and the third client device and/or between the second client device and the third client device.

18. The computer implemented method of claim 17 further comprising:
(O) using the second communication link, providing an authenticated identity of the civilian to the third client device.

19. The computer implemented method of claim 13 further comprising:
(H) enabling the first public servant to issue a traffic violation citation to the civilian and to send it from the first client device to the second client device;
(I) enabling the civilian to sign the traffic violation citation on the second client device;
(J) sending the signed traffic violation citation from the second client device to the first client device.

20. The computer implemented method of claim 13 further comprising:
(D)(1) storing to a database at least some communications over the first communication link between the first client device and the second client device.
